(19) United States
(12) Patent Application Publication
(10) Pub. No.: US 2014/0333409 A1
(43) Pub. Date: Nov. 13, 2014

(54) COIL

(71) Applicant: KABUSHIKI KAISHA TOYOTA JIDOSHOKKI, Aichi-ken (JP)

(72) Inventor: Hiroshi ONO, Kariya-shi (JP)

(73) Assignee: KABUSHIKI KAISHA TOYOTA JIDOSHOKKI, Aichi-ken (JP)

(21) Appl. No.: 14/256,459

(22) Filed: Apr. 18, 2014

(30) Foreign Application Priority Data
May 10, 2013 (JP) 2013-100451

(51) Int. Cl. H01F 5/06

(52) U.S. Cl. CPC H01F 5/06
USPC 336/223

(57) ABSTRACT

A coil includes a conductive wire formed spirally in the axial direction of the coil and an insulator formed in a strip-like spiral shape in the axial direction of the coil. A conductive member as the conductive wire of the coil is applied on at least one surface of the insulator.

### BACKGROUND OF THE INVENTION

The present invention relates to a coil.

Japanese Patent No. 3737461 and Japanese Patent Application Publication 2007-305803 disclose coils and methods for forming a coil by edgewise winding a flat wire.

Edgewise coils may be made by winding a wire formed of a copper plate previously coated with insulating film or winding a wire formed of a copper plate edgewise and then coating the wire with insulating film. When a wire 100 made of a copper plate is bent for edgewise winding as shown in FIG. 7, the inner part of the wire 100 at the bend thereof may expand and the insulating film on the wire 100 may be broken. If the wire 100 is made using a thinner copper plate, or a copper plate with a reduced dimension W, the dimension L of the wire 100 needs to be increased to maintain the original cross-sectional area. In such a case, the wire 100 needs to be bent with a larger radius of curvature and tensile stress occurs in the outer corner of the wire 100 at the bend thereof. As a result, the insulating film on the wire 100 at the bend may be broken. On the other hand, compression stress occurs in the inner corner of the wire 100 at the bend thereof. Because the inner edge at the bend of the wire 100 is restricted from expanding inwardly by the presence of a bending die (not shown in the drawing) which is set at the inner edge of the wire 100 at the bend, the copper plate of the wire 100 expands in the thickness direction at the bend thereof.

Therefore, the extent of reducing the dimension W and simultaneous increasing the dimension L of the copper wire 100 is limited. Furthermore, when the wire 100 is wound in an overlapped manner as shown in FIG. 8A, a gap GA is formed between two adjacent turns of the wire 100 due to the expansion occurring in the wire 100 during the edgewise winding. No gap GA is formed between the turns, as shown in FIG. 8B, if no expansion occurs in the wire 100 during the winding. Thus, the expansion in the wire 100 shown in FIG. 8A causes the dimension of the resulting coil in the axial direction thereof to increase for the same number of turns of the wire 100.

The present invention is directed to providing a coil whose axial length can be shortened.

### SUMMARY OF THE INVENTION

A coil includes a conductive wire formed spirally in the axial direction of the coil and an insulator formed in a strip-like spiral shape in the axial direction of the coil. A conductive member as the conductive wire of the coil is applied on at least one surface of the insulator.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1A is a schematic perspective view of a coil with a core according to an embodiment of the present invention and FIG. 1B is a schematic front view of the coil with the core of FIG. 1A;

FIG. 2A is a schematic perspective view of the coil of FIG. 1A with the core removed for clarity, FIG. 2B is a schematic front view of the coil of FIG. 2A and FIG. 2C is a sectional view taken along the line A-A of FIG. 2B;

FIG. 3A is a schematic perspective view of a insulator in the coil of FIG. 2A, FIG. 3B is a schematic front view of the insulator of FIG. 3A, FIG. 3C is a sectional view taken along the line A-A of FIG. 3B and FIG. 3D is a schematic perspective view illustrating a mask area of the insulator of FIG. 3A;

FIG. 4A is a schematic perspective view of a insulator of a coil according to another embodiment of the present invention, FIG. 4B is a schematic front view of the insulator of FIG. 4A and FIG. 4C is a sectional view taken along the line A-A of FIG. 4B;

FIG. 5A is a schematic front view of a coil including the insulator of FIG. 4A and FIG. 5B is a sectional view taken along the line A-A of FIG. 5A;

FIG. 6A is a schematic fragmentary front view of a coil according to another embodiment of the present invention and FIG. 6B is a sectional view taken along the line A-A of FIG. 6A;

FIG. 7 is a schematic fragmentary perspective view illustrating a coil formed by edgewise winding according to a background art; and

FIGS. 8A and 8B are sectional views of the coil of FIG. 7.

### DETAILED DESCRIPTION OF THE EMBODIMENTS

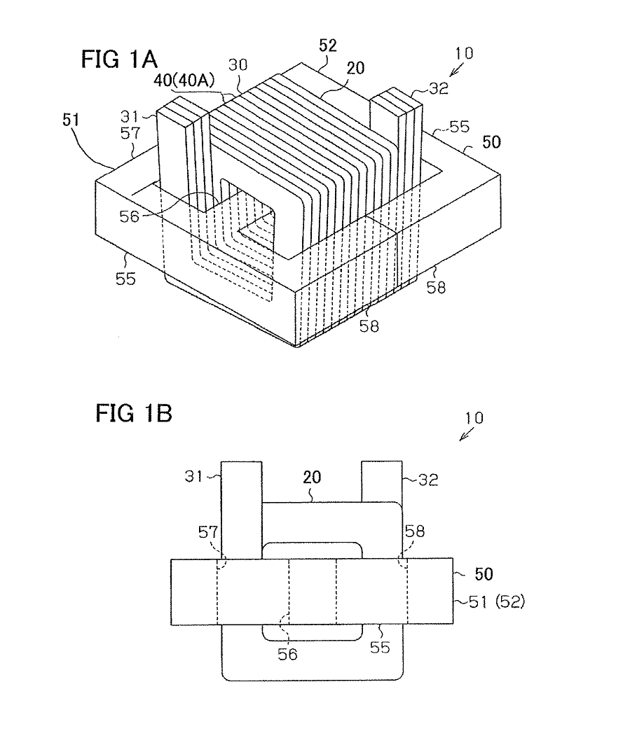

The following will describe the embodiments of the present invention with reference to the accompanying drawings. Referring to FIG. 1, numeral 10 designates a coil component 10 which includes a coil 20 and a core 50. The core 50 is an E-E type core that is composed of an E type core 51 and an E type core 52.

Each of the E type cores 51, 52 includes a base part 55 having a rectangular shape and extending horizontally, a center magnetic leg 56 extending from the center on one side of the base part 55 and two outer magnetic legs 57, 58 extending from the opposite ends on the one side of the base part 55. The magnetic legs 56, 57, 58 are rectangular in cross section.

The E type cores 51, 52 are joined together by abutting the ends of the center magnetic legs 56 and of the outer magnetic legs 57, 58 of the cores 51, 52. A coil 20 is formed in a spiral shape around the center magnetic legs 56 of the E type cores 51, 52.

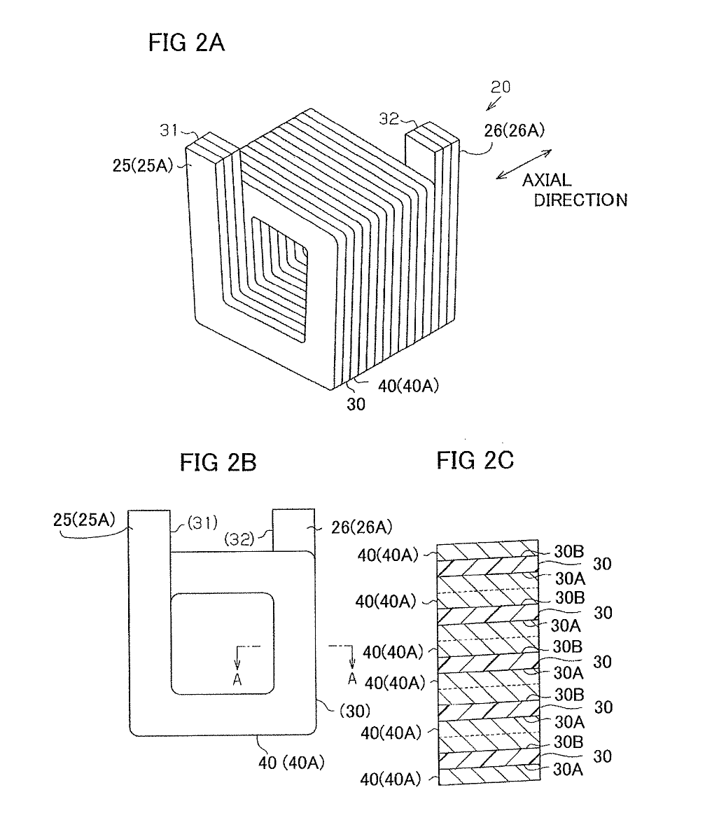

Referring to FIGS. 2A, 2B and 2C, the coil 20 includes a conductive wire 40A formed in a spiral shape in the axial direction of the coil 20. The conductive wire 40A is made of copper. The coil 20 further includes an insulator 30 formed in a strip-like spiral shape in the axial direction of the coil 20.

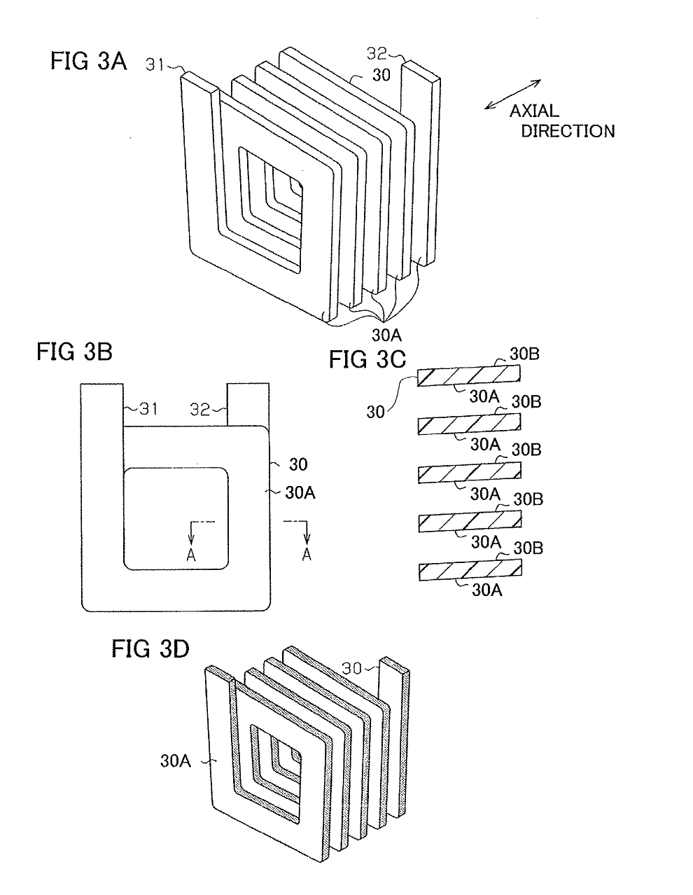

Referring to FIGS. 3A, 3B and 3C, the insulator 30 is formed of a strip having a rectangular cross section and formed in a spiral winding in the axial direction of the coil 20. The insulator 30 is made of a resin and formed by extrusion molding. Specifically, the insulator 30 is made by extruding resin into a strip formed into a spiral winding. The thickness of the insulator 30 is about 0.1 mm.

Referring to FIGS. 2A, 2B and 2C, a conductive member 40 functioning as the conductive wire 40A is applied to the insulator 30 on the opposite surfaces of thereof, or a main surface 30A and a backside surface 30B of the insulator 30 as shown in FIG. 3C. The conductive member 40 is formed of plated copper coating. The thickness of the conductive member 40 is about 0.1 mm. In an overlapped area of the insulator 30 formed in a winding shape, the conductive member 40 applied on the main surface 30A of the insulator 30 is in contact with the conductive member 40 applied on the backside surface 30B of the insulator 30. No conductive member such as 40 is applied on edge surfaces (indicated by shading in FIG. 3D) of the insulator 30.

In the overlapped area of the insulator 30 formed in a winding shape, the conductive member 40 applied on one surface of the insulator 30, or the main surface 30A may be separated from the conductive member 40 applied on the other side of the insulator 30, or the backside surface 30B.

As shown in FIGS. 3A, 3B and 3C, the insulator 30 formed in a spiral shape in the axial direction of the coil 20 has at one end thereof a terminal 31 extending upward. Similarly, the insulator 30 has at the other end thereof a terminal 32 extending upward.

As shown in FIGS. 2A, 2B and 2C, the conductive member 40 functioning as the conductive wire 40A is also applied to the terminals 31, 32 of the insulator 30. Thus, one end of the coil 20 extending upward is used as a terminal 25A. Similarly, the other end of the coil 20 extending upward is used as a terminal 26A.

The following will describe a method of producing the coil component 10. Firstly, a method of molding the coil 20 will be described. As shown in FIGS. 3A, 3B and 3C, the insulator 30 is formed by molding resin into a spiral shape in the axial direction of the coil 20. Thus, the insulator 30 formed into a coil shape is made previously. Then, the conductive coil 20 is made by applying conductive material to the insulator 30. Immersion plating may be used for applying the conductive material to the insulator 30.

In the plating, the inner and the outer edge surfaces of the insulator 30 that are indicated by shading in FIG. 3D should be masked by using masking tape to prevent such surfaces of the insulator 30 from being plated by the conductive material. Alternatively, in the case when no masking is used in the plating, plated copper coating on the edge surfaces of the insulator 30 can be removed. The edge surfaces then may be covered with any insulating coating as required.

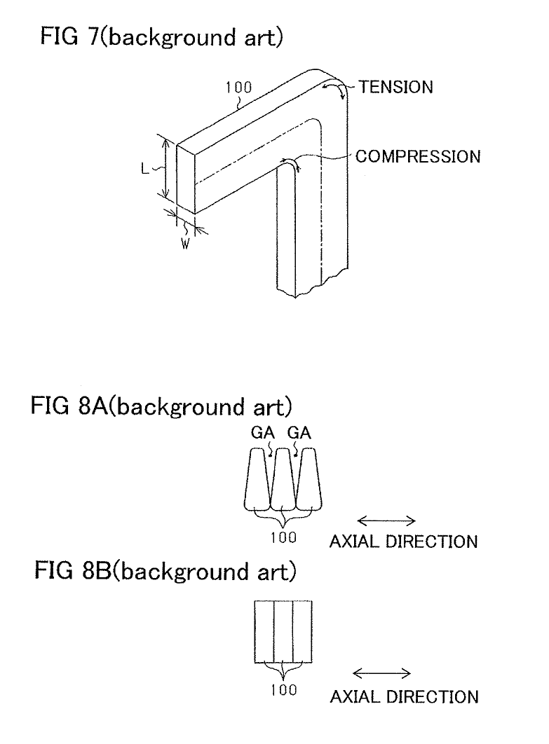

As described earlier with reference to FIGS. 7, 8A and 8B, the coil according to the background art is problematic in that the insulating film on the wire 100 with the dimension W that is far smaller than the dimension L of the wire 100 tends to be broken and also that the extent of reducing the dimension W and simultaneous increasing the dimension L of the copper wire 100 is limited and the expansion in the wire 100 causes the dimension of the resulting coil in the axial direction thereof to increase for the same number of turns of the wire 100.

In the embodiment according to the present invention, on the other hand, applying the insulator 30 formed spirally in the axial direction of the coil 20 with the conductive member 40 functioning as the conductive wire can reduce the thickness of the conductive member 40, increase the width of the conductive member 40 and prevent swelling of the coil 20. In addition, the manufacturing cost of the coil 20 can be reduced because molding a resin insulating material is easier than molding a metal wire in forming a coil. Furthermore, the coil 20 according to the illustrated embodiment enhances the freedom in designing the coil shape.

The coil component 10 shown in FIGS. 1A and 1B is made by inserting the center magnetic legs 56 of the E type cores 51, 52 into the coil 20 with the center magnetic legs 56 and the outer magnetic legs 57, 58 of the respective E type cores 51, 52 set in abutment with each other as shown in FIGS. 1A and 1B.

The coil of the above-described embodiment offers the following advantageous effects.

(1) The coil 20 according to the present embodiment includes the insulator 30 formed in a strip-like spiral shape in the axial direction of the coil 20 and the conductive member 40 functioning as the conductive wire 40A applied on the surfaces on the opposite sides of the insulator 30, or the main surface 30A and the backside surface 30B. According to such configuration of the coil 20, the coil length in the axial direction can be shortened as compared to a coil that is formed by bending a wire of a metal plate and wound in the same number of turns as the coil 20.

(2) The coil 20 having the conductive member 40 which is formed by plating is easy to manufacture. A planar coil is formed by winding a wire spirally in a plane. In the planar coil, the size of the coil in the radial direction thereof is increased with an increase in the number of turns and therefore, the number of turns in a coil is limited. Though the number of turns in a planar coil may be increased by lamination of a plurality of planar coils, the lamination makes it difficult to make the coil and limits the design options for the core. According to the present embodiment of the present invention, the number of turns of a coil may be increased without increasing the coil size. Additionally, the coil according to the embodiment is easy to manufacture and enhances the freedom of design of the cores.

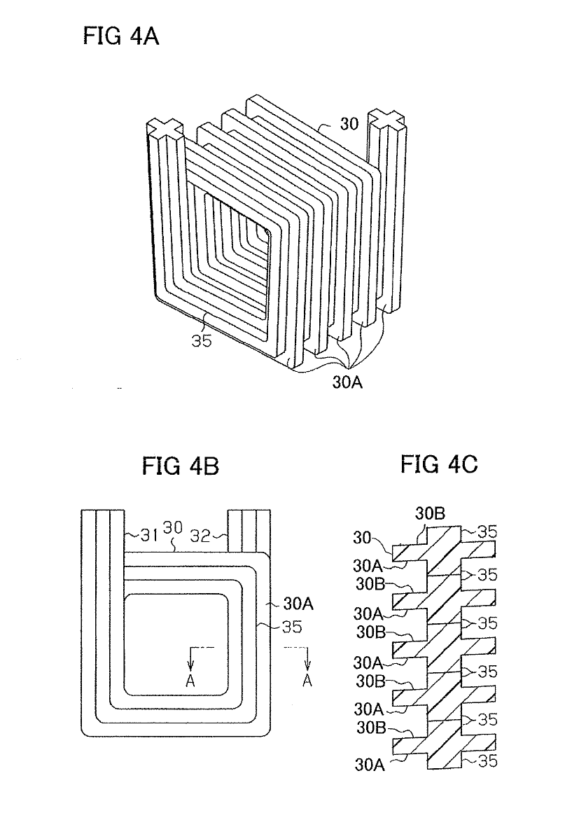

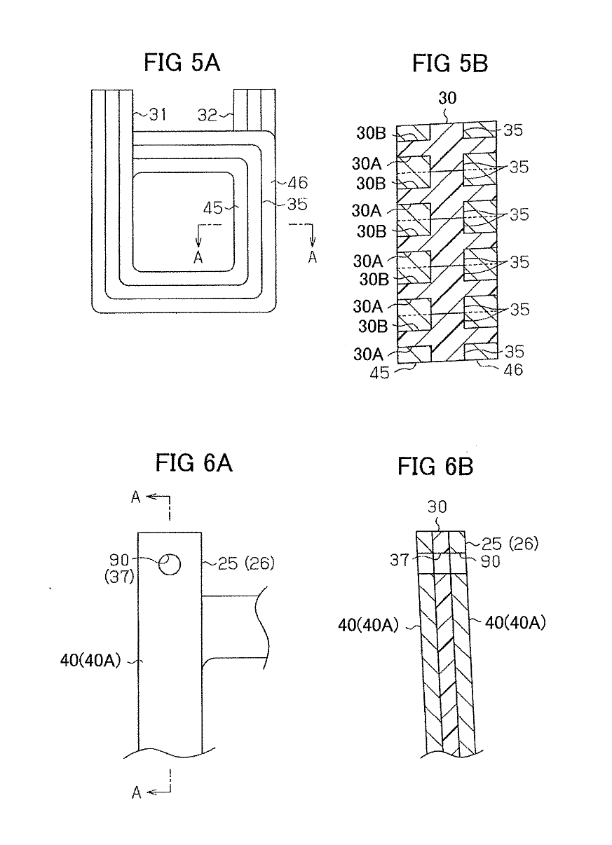

The present invention is not limited to the embodiment. The prevent invention may be embodied in various ways as exemplified below. Referring to FIGS. 4A, 4B and 4C, the insulator 30 is formed with projections 35 projecting in the axial direction of the resulting coil and extending spirally along the insulator 30. Referring to FIGS. 5A and 5B, a first conductive member 45 as a conductive wire formed inward of the insulator 30 and a second conductive member 46 as a conductive wire formed outward of the insulator 30 are sectioned by the projections 35 and formed. If one end of the first conductive member 45 and one end of the second conductive member 46 are electrically connected to each other by external connecting means, the number of turns of the coil can be increased, or doubled. Thus, the provision of the projections 35 in the insulator 30 can increase the number of the turns of the coil.

As shown in FIGS. 6A and 6B, in the coil 20, a hole 37 at one end and the other end of the insulator 30 and holes 90 at ends 25, 26 of the conductive members 40 applied on the opposite surfaces of the insulator 30 may be formed. The hole 37 and the holes 90 are formed for receiving therethrough a fastener such as a screw. Thus, the coil 20 can be connected at the ends thereof easily to any external device via the fastening screws passed through the holes 37 and the holes 90.

According to the present invention, the conductive member 40 may be applied only on one of the main surface 30A and the backside surface 30B. That is, the conductive member 40 functioning as a conductive wire may be applied on at least one surface of the insulator 30.

The conductive member 40 may be made of any other suitable metal such as aluminum, as well as copper. The conductive member 40 may be coated with a film of nickel plating, aluminum plating or the like other than copper plating.

The conductive member 40 may be made of metal foil, for example, copper foil other than copper plating. For example, metal foil may be applied on the surface of the insulator 30 which is being formed by extrusion molding. An insulator of a ceramic may be used instead of the insulator 30 made of a resin.

Though FIGS. 1A and 1B show the coil 20 with the core 50, the core 50 may be dispensed with. The coil according to the prevent invention is applicable to a transformer.

What is claimed is:

1. A coil comprising:
a conductive wire formed spirally in the axial direction of the coil; and
an insulator formed in a strip-like spiral shape in the axial direction of the coil, wherein a conductive member as the conductive wire is applied on at least one surface of the insulator.

2. The coil according to claim 1, wherein the conductive member is formed of plated coating.

3. The coil according to claim 1, wherein the conductive member is made of metal foil.

4. The coil according to claim 1, wherein the insulator is formed with projections projecting in the axial direction of the coil and extending spirally along the insulator, wherein a first conductive member as a conductive wire formed inward of the insulator and a second conductive member as a conductive wire formed outward of the insulator are sectioned by the projections and formed.

5. The coil according to claim 1, wherein a hole at the ends of the insulator and a hole at the ends of the conductive member as the conductive wire are formed for receiving therethrough a fastener.
